(19) United States
(12) Patent Application Publication
(10) Pub. No.: US 2013/0001145 A1
(43) Pub. Date: Jan. 3, 2013

(54) Micro-Machined Frit and Flow Distributor Devices for Liquid Chromatography

(75) Inventors: Hongfeng Yin, Cupertino, CA (US); Qing Bai, Sunnyvale, CA (US); Reid A. Brennen, San Francisco, CA (US)

(73) Assignee: Agilent Technologies, Inc., Santa Clara, CA (US)

(21) Appl. No.: 13/172,034

(22) Filed: Jun. 29, 2011

(51) Int. Cl. B01D 15/08; B32B 17/00; B01D 15/18; B32B 3/10

(52) U.S. Cl. 210/198.2; 428/131; 428/136; 428/137; 96/105

(57) ABSTRACT

A micro-machined frit is provided for use in a chromatography column, having a substrate with a thickness, and holes extending through the thickness and providing fluid communication through the substrate. A micro-machined flow distributor is provided for use in a chromatography column having a substrate, holes extending through the substrate, and channels in fluid communication with the holes. A micro-machined integrated frit and flow distributor device is also provided having a substrate with a thickness, holes extending through the thickness and providing fluid communication therethrough, and channels in fluid communication with at least one of the holes. A chromatography column is provided having a tube, an extraction medium contained therein, and a micro-machined frit positioned proximate an end of the tube. The column can include a micro-machined flow distributor positioned between the frit and the end of the tube.

### FIELD OF THE INVENTION

This invention relates generally to the field of frits and flow distributor devices for liquid chromatography, and chromatography columns and systems incorporating the same.

### BACKGROUND OF THE INVENTION

Liquid chromatography is a widely used separation technique. In liquid chromatography, a liquid sample is passed through a column of the chromatography system and, more specifically, through a packing or extraction medium contained within the column. For example, a liquid, such as a solvent, is passed through the column and a sample to be analyzed is injected into the column. As the sample passes through the column with the liquid, the different compounds in the sample, each one having a unique affinity for the extraction medium, move through the column at different speeds. The compounds having a greater affinity for the extraction medium move more slowly through the column than those having less affinity, resulting in the compounds being separated from each other as they pass through the column. Traditionally, frits are positioned within the column to contain the extraction medium, while allowing the liquid and sample to pass through the column. Such frits are traditionally formed of sintered metal, resulting in a porous frit with pores of varying and inconsistent sizes. Recent technological developments have resulted in smaller particles being used in the extraction medium.

Standard sintered frits pose two problems. First, due to the porous nature of the frits, the sample to be analyzed is exposed to increased surface area within the frit, which can result in increased interaction between the sample and the frit, which is not desirable. Additionally, as the particles in the extraction medium are reduced in size, they may get stuck or embedded in the larger pores of the frit, which can affect fluid flow through the frit.

Flow distribution chambers are often used in chromatography systems to help control the flow of the sample through the chromatography column. Traditionally, these have been conical-shaped chambers positioned between the inlet capillary and the inlet-side frit, and the outlet-side frit and outlet capillary. Such chambers offer no mechanical strength or support to the frits, thus the frits are subjected to the full force of the fluid flow. While these chambers may be generally effective for flow distribution, there may be room for improvement with regard to evenly distributing the fluid flow across the frit (at the inlet end for example), or evenly concentrating the fluid flow at the outlet end for analysis. If the fluid flow exiting the chromatography column is not evenly concentrated, the eluting peak(s) of the sample will be disturbed, resulting in less accurate analyses of the liquid sample.

Thus, there is a need in the art for frits and/or flow distributor devices for use in chromatography columns that can effectively hold back extraction media particles of decreased sizes. There is also a need in the art for frits and/or flow distributor devices that can withstand the pressures of fluid flow through the columns. Additionally, there is a need for frits and/or flow distributor devices that reduce the surface area to which the sample is subjected as it passes through the frit(s) and/or flow distributor(s). Finally, there is a need in the art for frits and/or flow distributors that maintain a more even flow of fluid through the column, and thus minimize disturbance of the eluting peak of analyte as it exits the chromatography column.

### SUMMARY OF THE INVENTION

According to various embodiments, a micro-machined frit is provided for use in a chromatography column. The frit can comprise a substrate having a first surface, an oppositely disposed second surface, and a thickness. The substrate can define a plurality of holes extending through the thickness, each of the holes having a first end positioned on the first surface and an opposed second end positioned on the second surface. For each of the holes, the first end can be aligned with the second end. The holes can provide fluid communication through the substrate.

In various other embodiments, a micro-machined flow distributor is provided for use in a chromatography column. The flow distributor can comprise a respective substrate having a first surface and an oppositely disposed second surface. The flow distributor can further comprise a plurality of holes positioned in and extending through the substrate, each hole having a first end and an opposed second end. The second end of each hole can be positioned on the second surface. The flow distributor can also comprise a plurality of channels defined in the first surface, each of the channels in fluid communication with a first end of at least one hole. According to a further embodiment, the flow distributor can have a cavity positioned in the first surface, and each channel can extend between the cavity and the respective first end of the at least one hole and provide fluid communication therebetween.

In yet other embodiments, a micro-machined integrated frit and flow distributor device is provided for use in a chromatography column. The device can comprise a substrate having a first surface, a second surface oppositely disposed from the first surface, and a third surface spaced from the second surface. The substrate can have a thickness between the first and second surfaces, and can define a plurality of holes extending through the thickness. Each hole can have a first end positioned on the first surface and a second end positioned on the second surface. In one embodiment, for each hole the first end is aligned with the second end. The holes can provide fluid communication through the substrate. The device can also comprise a plurality of channels defined in the third surface, each channel being in fluid communication with at least one of the plurality of holes.

According to yet other embodiments, a chromatography column is provided that comprises a tube, an extraction medium, and at least one micro-machined frit. The tube has an inlet end and an opposed outlet end. The extraction medium is contained within the tube and comprises particles having an average dimension. The at least one frit can be positioned proximate one of the inlet end and outlet end of the tube. The frit, according to various embodiments, can comprise a first substrate having a first surface, an oppositely disposed second surface, and a thickness. The first substrate can define a plurality of first holes extending through the thickness. Each of the first holes can have a first end positioned on the first surface and an opposed second end positioned on the second surface. For each hole, the first end can be aligned with the second end. The holes can provide fluid communication through the substrate.

According to further embodiments, the chromatography column can further comprise at least one micro-machined flow distributor positioned between the frit and the respective inlet or outlet end of the tube. The flow distributor can comprise a second substrate having a first surface and an oppositely disposed second surface. The flow distributor can comprise a plurality of second holes positioned in and extending through the second substrate, each of the second holes having a first end and an opposed second end positioned on the second surface of the second substrate. The flow distributor can also comprise a plurality of channels defined in the first surface of the second substrate, each channel being in fluid communication with a first end of at least one of the second holes. In one embodiment, each of the first holes of the at least one frit is in fluid communication with at least one of the second holes of the at least one flow distributor.

Additional advantages of the invention will be set forth in part in the description which follows, and in part will be obvious from the description, or may be learned by practice of the invention. The advantages can be realized and attained by means of the elements and combinations particularly pointed out in the appended claims. It is to be understood that both the foregoing general description and the following detailed description are exemplary and explanatory only and are not restrictive of the aspects of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1A is a plan view of an exemplary frit, according to one embodiment.

FIG. 1B is a cross-sectional view of the frit of FIG. 1A taken along line 1B-1B of FIG. 1A.

FIG. 1C is a partial plan view of the frit of FIG. 1A on an enlarged scale as shown in circle 1C of FIG. 1A.

FIG. 2A is a top plan view of an exemplary frit, according to another embodiment.

FIG. 2B is a bottom plan view the frit of FIG. 2A.

FIG. 2C cross-sectional view of the frit of FIG. 2A taken along line 2C-2C of FIG. 2A.

FIG. 3A is a plan view of an exemplary frit, according to yet another embodiment.

FIG. 3B is a cross-sectional view of the frit of FIG. 3A taken along line 3B-3B of FIG. 3A.

FIG. 4A is a top plan view of an exemplary flow distributor, according to one embodiment.

FIG. 4B is a cross-sectional view of the flow distributor of FIG. 4A taken along line 4B-4B of FIG. 4A.

FIG. 5 illustrates the exemplary fluid flow path through the flow distributor of FIG. 4A.

FIG. 6A is a hidden-line top plan view of an exemplary layered flow distributor device, according to one embodiment.

FIG. 6B is a top plan view of a first layer of the flow distributor of FIG. 6A.

FIG. 6C is a cross-sectional view of the first layer of FIG. 6B taken along line 6C-6C of FIG. 6B.

FIG. 6D is a top plan view of a second layer of the flow distributor of FIG. 6A.

FIG. 6E is a bottom plan view of the second layer of FIG. 6D.

FIG. 6F is a cross-sectional view of the second layer of FIGS. 6D-6E taken along lines 6F-6F of FIGS. 6D and 6E.

FIG. 6G is a top plan view of a third layer of the flow distributor of FIG. 6A.

FIG. 6H is a bottom plan view of the third layer of FIG. 6G.

FIG. 6I is a cross-sectional view of the third layer of FIGS. 6G-6H taken along lines 6I-6I of FIGS. 6G and 6H.

FIG. 7A is a plan view of an exemplary integrated frit and flow distributor device, according to one embodiment.

FIG. 7B is a cross-sectional view of the device of FIG. 7A taken along line 7B-7B of FIG. 6A.

FIG. 8A is a plan view of an exemplary integrated frit and flow distributor device, according to another embodiment.

FIG. 8B is a cross-sectional view of the device of FIG. 8A taken along line 8B-8B of FIG. 8A.

FIG. 9A is a cross-sectional view of a chromatography column, according to one embodiment.

FIG. 9B is a partial cross-sectional view of the chromatography column of FIG. 9A on an enlarged scale as shown in circle 9B of FIG. 9A.

### DETAILED DESCRIPTION

The present invention may be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Thus, for example, reference to a “hole” can include two or more such holes unless the context indicates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Reference will now be made in detail to the present preferred embodiments of the invention, examples of which are illustrated in the accompanying drawings. Wherever possible, the same reference numbers are used throughout the drawings to refer to the same or like parts.

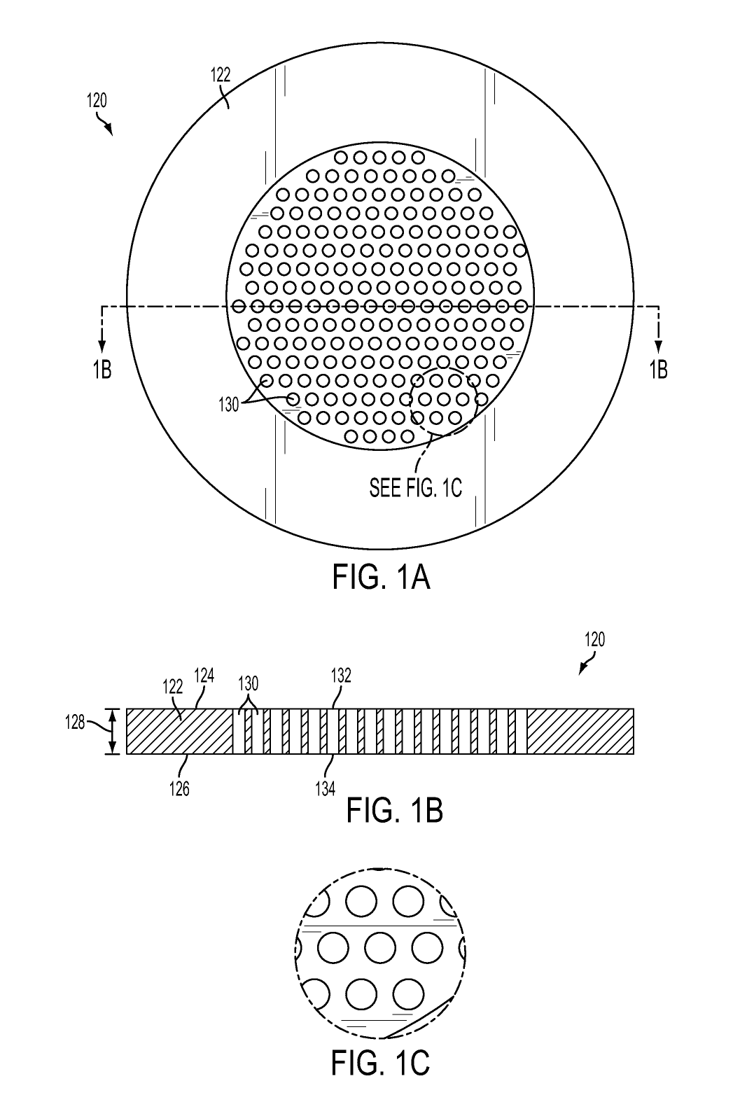

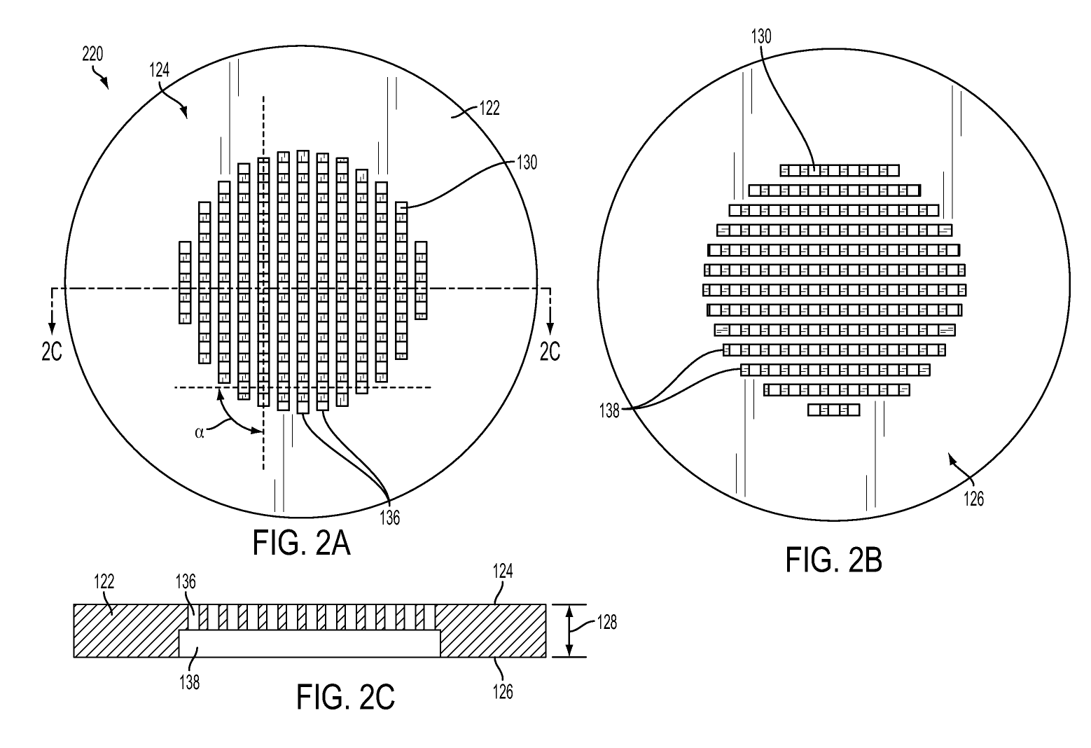

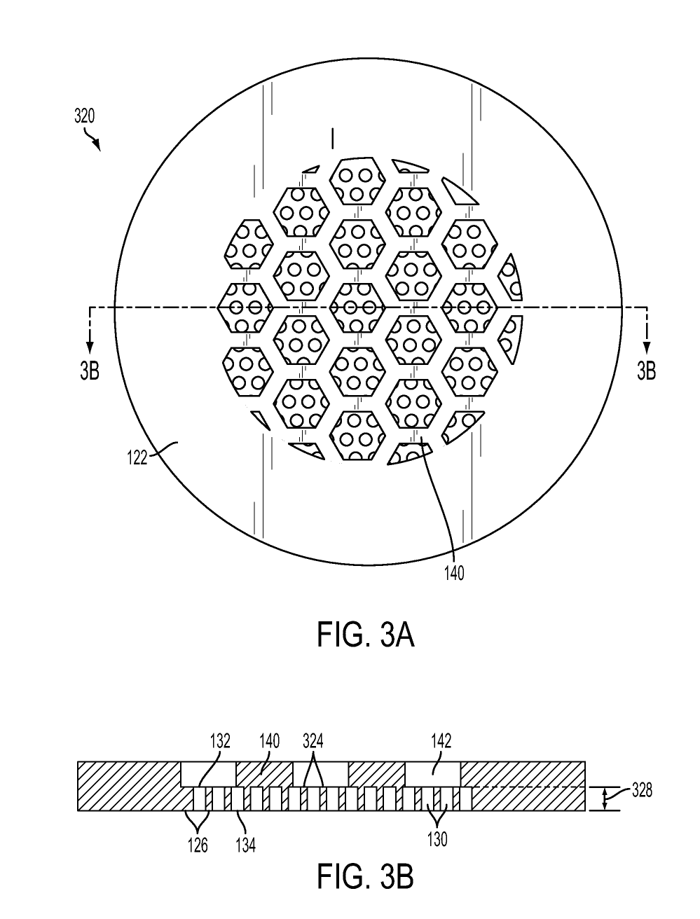

According to various embodiments, disclosed herein is a micro-machined frit for use in a chromatography column. An exemplary frit 120 is shown in FIGS. 1A-1B. Other exemplary frits (220 and 320) are shown in FIGS. 2A-2C and 3A-3B, respectively. Exemplary frits can comprise a substrate 122 having a first surface 124 and an oppositely disposed second surface 126, such as shown in FIG. 1B. As shown in FIGS. 1B and 2C, the first surface 124 can be the top-most surface (as viewed on the page) of the substrate, and the second surface 126 can be the bottom-most surface of the substrate. Optionally, either or both of the first and second surfaces can be surfaces lying at some distance from the top-most or bottom-most surface of the substrate. For example, as shown in FIG. 3B, the first surface 324 is positioned between the top-most surface of the substrate 122 and the second surface 126. As used herein, the terms top, bottom, upper or lower are not intended to limit the orientation of the particular component being described or the orientation in which such component must be used, unless so described. Thus, the top-most surface of the substrate 122 shown in FIG. 1B can equally describe the bottom-most surface if the substrate were flipped upside-down.

The substrate 122 has at least one thickness 128. The thickness can be the total thickness of the substrate and can extend between the first surface 124 and second surface 126, as shown in FIGS. 1B and 2C. Optionally, the thickness 328 can represent a portion of the total thickness of the substrate and can extend between recessed first surface 324 and the second surface 126 as shown in FIG. 3B. The substrate can further define a plurality of holes 130 extending through the respective thickness. Each of the holes can have a first end positioned on the first surface and an opposed second end positioned on the second surface. For example, as shown in FIGS. 1B and 2C, each hole 130 has a first end 132 positioned on the first surface 124 and an opposed second end 134 positioned on the second surface 126. Similarly, as shown in FIG. 3B, each hole 130 has a first end 132 positioned on the first surface 324 and an opposed second end 134 positioned on the second surface 126. The first and second end of each hole, in one embodiment, are aligned with each other. The holes provide fluid communication through the substrate. In yet a further embodiment, the holes 130 can be arranged in an array. The array can be an array of rows, such as shown in FIGS. 1A, 2A and 3A. Optionally, the array can be an array of columns, an array of rows and columns, an array of concentric circles, or in any other regular defined pattern. In yet another embodiment, the holes can be arranged in random positions or in a random pattern.

In one exemplary frit 230, as shown in FIGS. 2A-2C, the frit can comprise a plurality of first slots 136 formed in the first surface 124. The first slots can be substantially parallel to one another. The frit can also comprise a plurality of second slots 138 formed in the second surface 126. The second slots can be substantially parallel to one another, and can be oriented transversely to the plurality of first slots. For example, as shown in FIG. 2A, the second slots can be oriented at an angle α relative to the first slots. The angle α can be about 90°, in one embodiment. Optionally, the angle α can be an angle other than 90°, such as, but not limited to, about 75°, about 80°, about 85°, or some other angle. As can be seen in FIGS. 2A-2C, the first slots intersect the second slots, thereby forming the plurality of holes 130. As shown in FIG. 2C, the first slots 136 and second slots 138 can each extend approximately midway into the substrate, and thus the first slots and second slots would each have a depth of approximately half the thickness of the substrate. Optionally, the first and/or second slots can have a depth of more than or less than half the thickness of the substrate, and thus can intersect at a position other than midway into the substrate. In other embodiments, the slots can be from about 1 μm to about 20 μm wide. Optionally, the slots can be from about 1 μm to about 10 μm wide, or from about 1 μm to about 5 μm wide. In yet other embodiments, the slots can be from about 1 μm to about 2.5 μm wide.

Another exemplary frit 320 is shown in FIGS. 3A-3B. In this embodiment, the substrate 122 further comprises a support lattice 140 positioned on the first surface 324. As described above, in this embodiment, the first surface 324 is positioned at a distance from the top-most surface of the substrate 122, and the plurality of holes 130 have a first end 132 positioned on the first surface 324 and a second end 134 positioned on the second surface 126. The support lattice 140 defines a plurality of openings 142. As can be seen in FIGS. 3A and 3B, each opening is in fluid communication with at least one of the holes 130. The openings 142 shown in FIG. 3B are shown as being approximately hexagonal shape, but it is contemplated that exemplary openings defined in the support lattice of other embodiments can be of any shape, such as, but not limited to, circular, oblong, rectangular, square, other shapes, or a combination of shapes. According to a particular embodiment, it is contemplated that the openings can be formed of any shape that minimizes the area covered by the support lattice 140, thereby allowing as much fluid flow as possible to or from the holes 130. Furthermore, in FIG. 3B, the openings 142 are shown as extending approximately midway into the substrate 322, and the holes 130 similarly extend approximately midway into the substrate. However, it is contemplated that the openings can extend more or less than midway into the substrate, such as if the thickness 328 in which the holes are defined is less than or more than half the total thickness of the substrate, respectively.

According to various embodiments, each hole 130 as described herein can have a respective cross-dimension that is selected depending on the size of the particles of extraction medium that are contained within the chromatography column in which the frit will be used (described further herein below). In one example, each hole can have a respective cross-dimension of about 1 μm to about 10 μm. Optionally, each hole can have a respective cross-dimension of about 1 μm to about 5 μm. In yet another embodiment, each hole can have a respective cross-dimension of about 1 μm to about 2.5 μm. According to yet other embodiments, each hole can have a respective cross dimension of less than 1 μm or greater than 10 μm. For example, each hole 130 shown in FIGS. 1A and 3A has a substantially round cross-sectional shape, and can have a diameter of the above-described exemplary cross-dimensions. Optionally, as shown in FIG. 2A, each hole can have a square or rectangular cross-sectional shape, and each can have a width and/or length of the above-described exemplary cross-dimensions. Thus, the dimensions described above are intended to apply to any shape hole. According to some embodiments, the size and/or shape of each hole can be pre-defined and can be controlled by the method in which the frit is made (described further herein below).

Exemplary frits as described herein can have various dimensions, depending on the chromatography column in which they will be used. According to particular embodiments, the diameter of the frit would be substantially equal to, or slightly less than, the inner diameter of the tube of a chromatography column in which the frit is to be used. Similarly, the thickness of the frit (for example, the thickness between the first surface 124 and the second surface 126 as viewed in FIGS. 1B and 2C, or the thickness between the first surface 324 and the second surface 126 as viewed in FIG. 3B), can be any selected thickness that is sufficient for the frit to contain the extraction medium within the column (described further below), and sufficient to withstand the pressure of fluid flow therethrough the frit, and is not limited to the dimensions discussed below. In a particular embodiment, the ratio of the cross-dimension of the holes 130 to the thickness of the frit through which the holes extend can be from about 1:5 to about 1:20. According to other embodiments, the thickness of the frit can be about 5 μm to about 500 μm. In yet other embodiments, the thickness of the frit can be about 10 μm to about 100 μm. Optionally, the thickness of the frit can be about 10-90 μm, or about 10-80 μm, or about 10-70 μm, or about 10-60 μm, or about 10-50 μm, or about 10-40 μm, or about 10-30 μm, or about 10-20 μm, or about 15 μm. As discussed above, this thickness may be a total thickness of the frit, or a partial thickness.

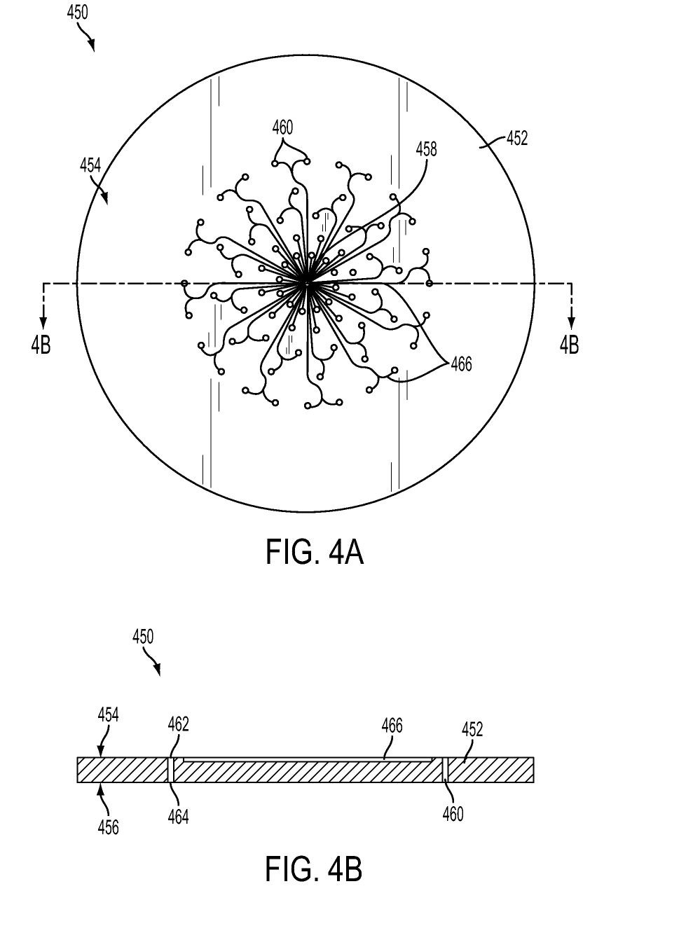

According to various embodiments, disclosed is a flow distributor for a chromatography column. An exemplary flow distributor 450 is shown in FIGS. 4A and 4B. The flow distributor 450 comprises a substrate 452 having a first surface 454 and an oppositely disposed second surface 456. The flow distributor also has a plurality of holes 460 positioned in and extending through the substrate 452. Each hole 460 has a first end 462, and a second end 464 positioned on the second surface 454. The flow distributor also has a plurality of channels 466 defined in the first surface 154. Each channel can be in fluid communication with a first end of at least one of the holes. In a further embodiment, the flow distributor 450 can have a cavity 458 positioned in the first surface 454. In this embodiment, each channel 166 can extend between the cavity 458 and a first end 462 of at least one of the holes 460, and can provide fluid communication between the cavity and the at least one hole. For example, as shown in FIG. 4A, some of the channels can branch off at a distal end into sub-channels, and can thus be in fluid communication with more than one hole 460.

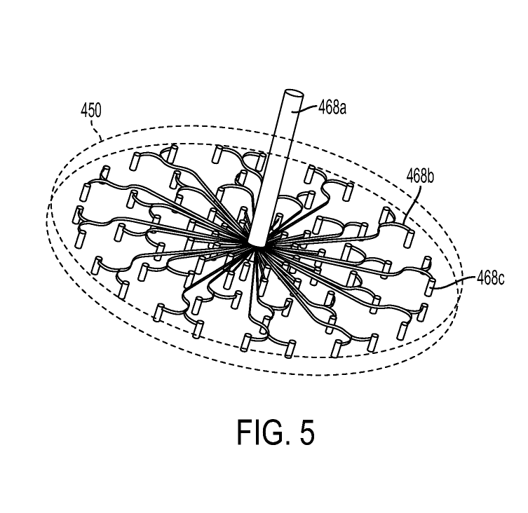

FIG. 5 illustrates the exemplary flow of fluid through a flow distributor, such as the one shown in FIG. 4A. As can be seen, the fluid can flow into the cavity (represented by fluid 468a), through each channel (represented by fluid 468b), and through each hole (represented by fluid 468c). Each channel 466 has a predetermined length. According to some embodiments, the predetermined lengths of the channels may differ, such as shown in FIG. 4A.

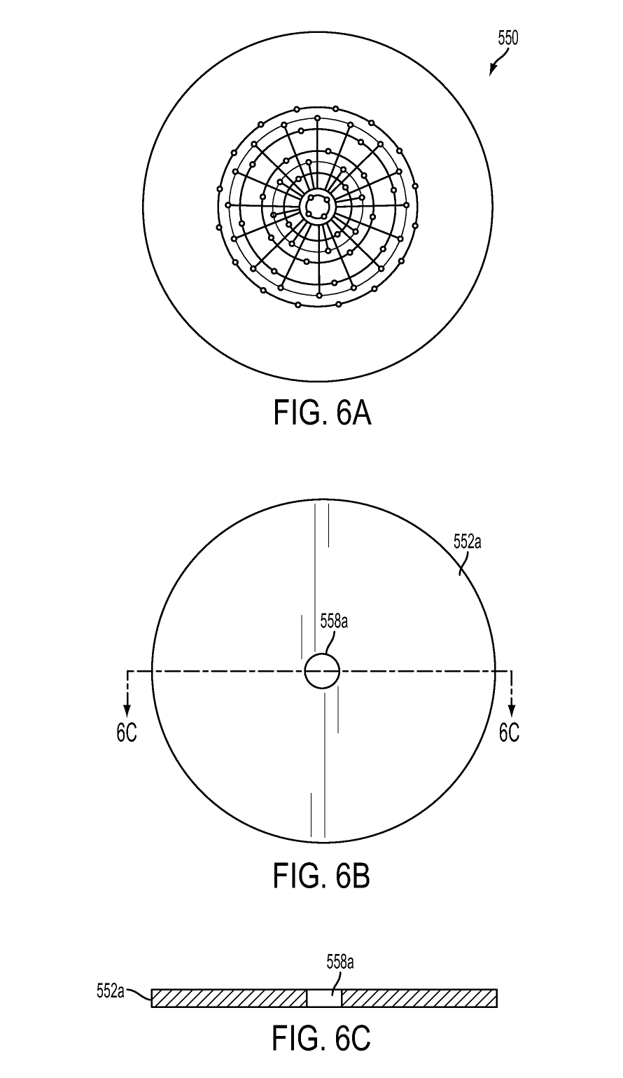

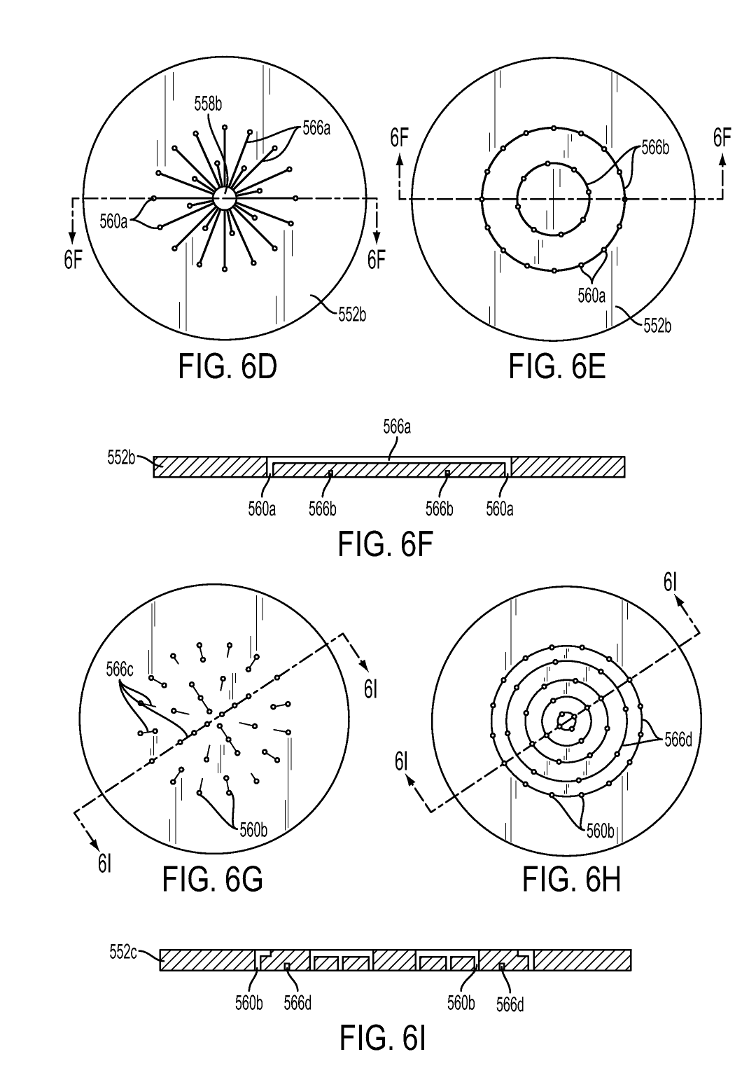

In one particular embodiment, the predetermined lengths of the plurality of channels are substantially equal to each other. Thus, as can be appreciated, the flow of fluid through the flow distributor through any path is substantially equal. The term “substantially equal” is not meant to refer to paths that are exactly equal to each other, but rather can encompass paths that differ up to 10% in length from one another. Such an exemplary embodiment can be seen in FIG. 6A, which shows a hidden-line view of an exemplary flow distributor 550. This particular flow distributor 550 is made up of three layers, each having at least one of a cavity, channel, and hole (such as previously described with regard to flow distributor 450). The layers would be stacked on top of each other and/or joined or bonded to one another to define fluid flow paths therethrough the flow distributor 550. A first layer is shown in 6B, which comprises a first substrate 552a, and defines a cavity 558a that extends through the first substrate 552a as shown in FIG. 6C (thus, a bottom view of the first substrate would appear substantially identical to the top view shown in FIG. 6B).

The second (or middle) layer is shown in FIGS. 6D-6F, and comprises a second substrate 552b. The second layer has a cavity 558b, which is in fluid communication with the cavity 558a of the first layer when the layers are stacked or joined to form the flow distributor 550. A plurality of holes 560a are positioned in and extend through the substrate 552b, as shown in FIG. 6F. A plurality of channels 566a are defined in the top surface of the second layer, as shown in FIGS. 6D and 6F, and extend and provide fluid communication between the second layer cavity 558b and a respective hole 560a. A plurality of channels 566b are formed in the bottom surface of the second layer, as shown in FIGS. 6E and 6F and provide fluid communication between the bottom ends of the holes 560a.

The third layer is shown in FIGS. 6G-6I, and comprises a third substrate 552c. The third layer has a plurality of channels 566c formed in the top surface of the third layer, as shown in FIGS. 6G and 6I. At least a portion of the channels 566c in the third layer are in fluid communication with the channels 566b formed in the bottom surface of the second layer when the layers are stacked or joined to form the flow distributor 550. A plurality of holes 560b are positioned in and extend through the substrate 552c, as shown in FIG. 6I. On the bottom surface of the third layer, as shown in FIG. 6H, are formed a plurality of channels 566d that are each in fluid communication with a respective plurality of the holes 560b. Thus, as fluid flows through the flow distributor 550 either from the first layer to the third layer, or vice versa, it is contemplated that each particle within the fluid travels a substantially equal distance (i.e., within 10%) as any other particle within the fluid.

With regard to the various flow distributors described herein, the dimensions of the various components (e.g., the diameter of the cavity, the width and/or depth of the channels, the diameters and depth of the holes, and/or the total thickness of the substrate) can vary depending on the diameter of the chromatography column with which the flow distributor is going to be used, how much fluid will pass through the column, and what would be considered an acceptable pressure drop of the fluid across the flow distributor. In one particular embodiment, for a standard 4.6 mm diameter chromatography column, the total diameter of the flow distributor can be approximately 7.32 mm in diameter, and can have a total thickness of approximately 100 μm. The channels can be about 20-24 μm wide, and about 10-15 μm deep. Thus, the length or depth of the holes can be about 85-90 μm. The holes can be about 50-60 μm in diameter. These dimensions are exemplary only, and are not intended to be limiting.

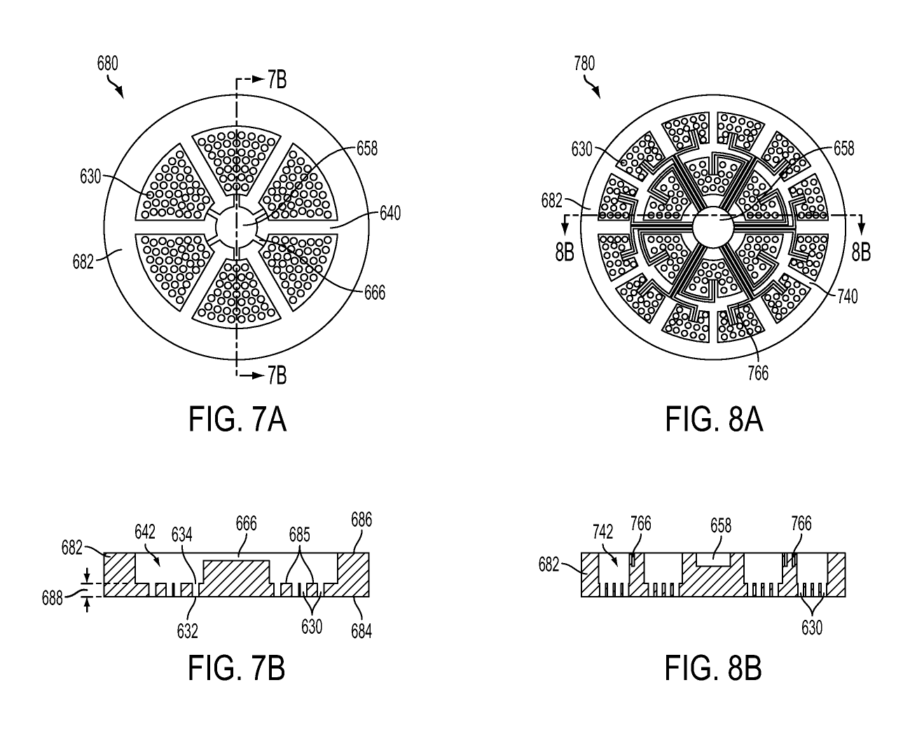

According to yet other embodiments, provided is an integrated frit and flow distributor device 680 for use in a chromatography column, such as shown in FIGS. 7A and 7B. Another exemplary integrated frit and flow distributor device 780 is shown in FIGS. 8A and 8B. The integrated frit and flow distributor device (680 or 780) comprises a substrate 682 having a first surface 684, a second surface 685 oppositely disposed from the first surface 684, and a third surface 686 spaced from the second surface 685. The substrate 682 has a thickness 688 between the first surface 684 and the second surface 685, as can be seen in FIG. 7B. As can be appreciated, the thickness 688 is less than a total thickness of the substrate. In one embodiment, the thickness can be any selected thickness that is sufficient for the device to contain the extraction medium within the column (described further below), and sufficient to withstand the pressure of fluid flow therethrough the device. According to particular embodiments, the thickness can be about 5 μm to about 500 μm. Optionally, the thickness can be about 10 μm to about 100 μm. In other embodiments, the thickness can be about 10-90 μm, or about 10-80 μm, or about 10-70 μm, or about 10-60 μm, or about 10-50 μm, or about 10-40 μm, or about 10-30 μm, or about 10-20 μm, or about 15 μm.

The substrate 682 defines a plurality of holes 630 extending through the thickness 688. Each hole 630 has a first end 632 positioned on the first surface 684, and a second end 634 positioned on the second surface 685. In one embodiment, for each hole, the first end is aligned with the second end, and the holes 630 provide fluid communication through the substrate 682. The integrated frit and flow distributor device also comprises a plurality of channels is defined in the third surface, such as channels 666 in FIG. 7A or channels 766 in FIG. 8A. Each channel is in fluid communication with at least one of the plurality of holes 630. In a further embodiment, the device can comprise a cavity 658 positioned in the third surface 686, and each channel can be in fluid communication with the cavity 658 and at least one of the plurality of holes 630.

In various embodiments, the device comprises a support lattice (640 in FIG. 7A, 740 in FIG. 8A) extending between the second surface 685 and the third surface 686. The support lattice defines a plurality of openings (642 or 742), such as shown in FIGS. 7A-8B. With reference to FIGS. 7A and 7B, for example, each opening 642 provides fluid communication between each channel 666 and at least one hole 630. Thus, as shown in FIGS. 7A and 7B, each opening 642 provides fluid communication between a channel 666 and a plurality of holes 630. Similarly, with reference to FIGS. 8A and 8B, each opening 742 provides fluid communication between each channel 766 and at least one hole 630.

In one embodiment, each channel 666 has a predetermined length. In a further embodiment, the predetermined lengths of the plurality of channels are substantially equal to each other, such as the channels 666 shown in FIGS. 7A and 7B, or the channels 766 shown in FIGS. 8A and 8B. In one embodiment, if all of the channels have a substantially equal length, the fluid flow through the flow distributor can be kept relatively constant, as each fluid particle traveling through the flow distributor has to travel substantially the same distance.

According to various embodiments, an integrated frit and flow distributor device can be formed by stacking and/or bonding or joining together individual frits (such as those described with respect to FIGS. 1A-3B) with individual flow distributors (such as those described with respect to FIGS. 4A-6I). In some embodiments, the individual components or features of the frits and flow distributors would have to be designed to work together, such as the placement of the holes in the frit and/or flow distributor.

As will be described further herein below, it is contemplated that exemplary frits, exemplary flow distributors, and exemplary integrated frit and flow distributor devices can be configured to pass fluid therethrough in any direction. Therefore, the term “flow distributor” is intended to also cover embodiments in which the flow is concentrated. Thus, with reference to FIGS. 8A and 8B, for example, the flow of fluid through the device 780 can follow a path into the cavity 658, through each channel 766, into each opening 742, and through each hole 630. Optionally, the flow of fluid through the device 780 can follow the opposite path, in which the fluid flows into each hole 630, into the openings 742, through the channels 766, and into the cavity 658, where it then leaves the device 780.

According to various embodiments, any of the exemplary frits, flow distributors, and/or integrated frit and flow distributor devices described herein can be micro-machined, according to various techniques. For example, micro-machining can be used to form the holes 130 in frits 120 or 320 (FIGS. 1A-1B and 3A-3B, respectively), the slots 136 and 138 in frit 220 (FIGS. 2A-2C), and/or the openings 142 formed in the support lattice 140 shown in FIGS. 3A and 3B. Similarly, micro-machining can be used to form the cavity 458, channels 466, and/or holes 460 in flow distributor 450 shown in FIG. 4A.

For example, micro-machining techniques such as etching or laser milling can be used. Etching techniques include deep reactive ion etching (RIE), dry etching, wet etching, plasma etching, electro-chemical etching, gas phase etching, and the like. Additionally, lithography techniques as known in the art can be used as a masking step to define the components (e.g., holes, cavities, channels, etc.) of the exemplary frits, flow distributors, and/or integrated devices. Etching techniques can then be used to form the components. With reference to FIG. 1, for example, lithography can be used as a masking step to expose the portions of the substrate 122 where the holes 130 are to be formed. Deep RIE can then be used to form the holes 130 through the substrate. According to various embodiments, by micro-machining the frits, flow distributors, and/or integrated devices described herein, the surface area with which the liquid sample comes into contact can be minimized, thereby minimizing any unwanted interaction with the liquid sample to be analyzed.

Additionally, it is contemplated that any of the exemplary substrates such as those described above with respect to the exemplary frits, flow distributors, and/or integrated frit and flow distributor devices, can be manufactured from various materials, including metal (such as, but not limited to stainless steel or titanium), glass, silica, polymers (such as, but not limited to, polyether ether ketone [PEEK]), or ceramics (such as, but not limited to, aluminum oxide).

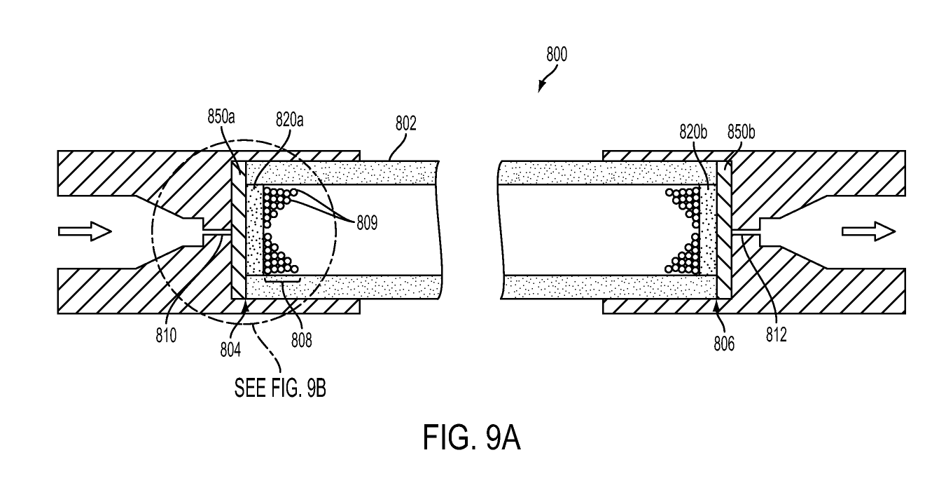

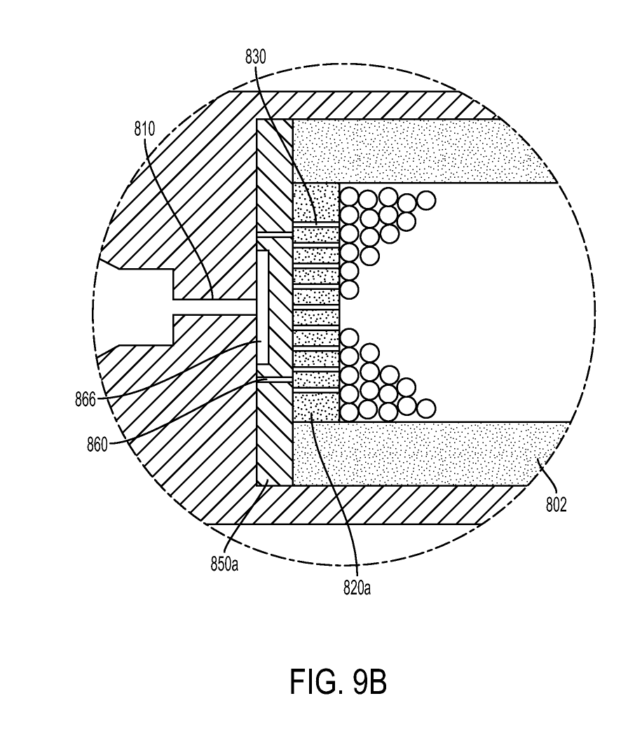

According to various other embodiments, disclosed is an exemplary chromatography column 800, such as shown in FIG. 9A. The chromatography column 800 comprises a tube 802 having an inlet end 804 and an opposed outlet end 806. An extraction medium 808 is contained within the tube, and comprises particles 809 having an average dimension. For example, if the particles are substantially spherical, each particle will have a respective diameter. While each particle may differ somewhat in size from other particles, the particles in totality have an average dimension, which, in this particular embodiment, would be an average diameter. According to one embodiment, the particles can have an average dimension of greater than about 5 μm. Optionally, the particles can have an average dimension of about 3.5 μm to about 5 μm. In another embodiment, the particles can have an average dimension of about 2 μm to about 3.5 μm. In yet another embodiment, the particles can have an average dimension of less than about 2 μm. Although only some particles of the extraction medium are shown in FIG. 9A, it is contemplated that substantially the entire tube 802 would be filled with the extraction medium 808 between the frits, as described below.

The chromatography column 800 further comprises at least one frit positioned proximate one of the inlet end 804 and outlet end 806 of the tube. The frit can be any of the frits disclosed herein above, and thus can comprise a first substrate having a first surface, an oppositely disposed second surface, and a thickness. The first substrate defines a plurality of holes that extend through the thickness, with each hole having a first end positioned on the first surface, and an opposed second end positioned on the second surface. The holes provide fluid communication through the first substrate. In one particular embodiment, the first end is aligned with the second end. As described above, in some embodiments, the holes can be arranged in an array of rows. Similarly as described above with respect to FIGS. 3A-3B, the first substrate can further comprise a support lattice positioned on the first surface. The support lattice can define a plurality of openings, each opening being in fluid communication with at least one of the holes.

In an additional embodiment, each hole has a respective cross-dimension that is less than the average dimension of the particles that make up the extraction medium. Thus, for example, if the particles have an average dimension of about 2 μm, then each hole can have a respective cross-dimension that is less than about 2 μm.

According to various embodiments, the chromatography column can further include at least one flow distributor positioned between the frit and the respective inlet end or outlet end of the tube. The flow distributor can be any of the flow distributors disclosed herein above. For example, the flow distributor can comprise a second substrate having a first surface, an oppositely disposed second surface. In a further embodiment, the second substrate can have a cavity positioned in the first surface of the second substrate. The flow distributor can also include a plurality of second holes that are positioned in and extend through the second substrate. As described previously, each of the second holes has a first end and an opposed second end positioned on the second surface of the second substrate. The flow distributor also comprises a plurality of channels defined in the first surface of the second substrate. Each channel can be in fluid communication with a first end of at least one of the second holes. Optionally, each channel can extend between the cavity and a first end of at least one of the second holes, and provides fluid communication therebetween. Each of the first holes of the frit is in fluid communication with at least one of the second holes of the flow distributor.

In the particular embodiment shown in FIG. 9A, the chromatography column comprises two fits, the first frit 820a positioned proximate the inlet end 804, and the second frit 820b positioned proximate the outlet end 806. The extraction medium 808 is contained between the first frit 820a and the second frit 820b. A first flow distributor 850a is positioned between the first frit and the inlet end, and a second flow distributor 850b is positioned between the second frit and the outlet end. According to a further embodiment, the orientation of the frit and flow distributor on either end of the tube are mirrored opposites to each other. Thus, the second surfaces of both the first frit and the second frit are in contact with the extraction medium. Similarly, the cavity and channels of the flow distributors face away from the frits.

In use, and with reference to FIGS. 9A and 9B, the exemplary chromatography column 800 receives a fluid (such as a liquid sample for analysis) through the inlet capillary 810 (the flow direction being indicated by the large arrows in FIG. 9A). The fluid passes from the inlet capillary into the cavity 858 of the first flow distributor 850b, through the channels 866, and through the second holes 860. The fluid then passes through the holes 830 of the first frit 820a. Optionally, a frit comprising a support lattice defining openings can be used (such as the frit shown in FIGS. 3A-3B). In this embodiment, the fluid would pass from the second holes 860 of the first flow distributor 850b to the openings in the support lattice, and then through the holes 830 of the first frit.

The fluid then passes through the extraction medium, as is known in standard liquid chromatography. At the outlet end of the tube, the fluid passes through the second frit 820b and second flow distributor 850b in an opposite manner as previously described. Thus, the fluid passes through the holes of the second frit (and, optionally, into the openings of the support lattice of the second frit), through the holes of the second flow distributor, through the channels of the second flow distributor, and into the cavity of the second flow distributor. From the cavity, the fluid passes into the outlet capillary 812, where it can be passed to other components of a chromatography system for further analysis.

Although described above with regard to separate frit and flow distributors, it is contemplated that the integrated frit and flow distributor devices as described herein can be used in a chromatography column. In such an example, similarly as described immediately above, the cavity positioned in the third surface of the integrated device would be in direct fluid communication with the inlet capillary and/or the outlet capillary. The first surface of the substrate would be in contact with the extraction medium contained within the tube.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A micro-machined frit for use in a chromatography column, said frit comprising:
a substrate having a first surface, an oppositely disposed second surface, and a thickness, said substrate defining a plurality of holes extending through said thickness, each of said holes having a first end positioned on said first surface and an opposed second end positioned on said second surface, wherein for each of said holes, said first end is aligned with said second end, and wherein said holes provide fluid communication therethrough said substrate.

2. The frit of claim 1, wherein said holes are arranged in an array.

3. The frit of claim 1, further comprising:
a plurality of first slots formed in said first surface and substantially parallel to one another; and
a plurality of second slots formed in said second surface and substantially parallel to one another, said plurality of second slots being oriented transversely to said plurality of first slots, wherein said plurality of first slots intersect said plurality of second slots thereby forming said plurality of holes.

4. The frit of claim 1, wherein said substrate comprises a support lattice positioned on said first surface, wherein said support lattice defines a plurality of openings, wherein each of said openings is in fluid communication with at least one of said holes.

5. The frit of claim 1, wherein each of said holes has a respective cross-dimension of about 1 μm to about 2.5 μm.

6. The frit of claim 1, wherein said thickness is from about 10 μm to about 100 μm.

7. A micro-machined flow distributor for a chromatography column, said flow distributor comprising:
a substrate having a first surface and an oppositely disposed second surface;
a plurality of holes positioned in and extending through said substrate, each of said holes having a first end and an opposed second end positioned on said second surface; and
a plurality of channels defined in said first surface, each of said channels in fluid communication with a first end of at least one of said holes.

8. The flow distributor of claim 7, wherein each channel has a predetermined length, and wherein the predetermined lengths of the plurality of channels are substantially equal to each other.

9. A micro-machined integrated frit and flow distributor device for use in a chromatography column, said device comprising:
a substrate having a first surface, a second surface oppositely disposed from said first surface, and a third surface spaced from said second surface, said substrate having a thickness between said first and second surfaces, said substrate defining a plurality of holes extending through said thickness, each of said holes having a first end positioned on said first surface and a second end positioned on said second surface, wherein for each said holes, said first end is aligned with said second end, and wherein said holes provide fluid communication therethrough said substrate; and
a plurality of channels defined in said third surface, each of said channels in fluid communication with at least one hole of said plurality of holes.

10. The device of claim 9, wherein each channel has a predetermined length, and wherein the predetermined lengths of the plurality of channels are substantially equal to each other.

11. The device of claim 9, wherein said substrate comprises a support lattice extending between said second surface and said third surface, wherein said support lattice defines a plurality of openings, wherein each of said openings provides fluid communication between at least one channel and at least one hole of said plurality of holes.

12. A chromatography column comprising:
a tube having an inlet end and an opposed outlet end;
an extraction medium contained within said tube, said extraction medium comprising particles having an average dimension; and
at least one micro-machined frit positioned proximate one of said inlet end and said outlet end of said tube, said at least one frit comprising a first substrate having a first surface, an oppositely disposed second surface, and a thickness, said first substrate defining a plurality of first holes extending through said thickness, each of said first holes having a first end positioned on said first surface and an opposed second end positioned on said second surface, wherein for each of said holes, said first end is aligned with said second end, and wherein said holes provide fluid communication therethrough said first substrate.

13. The chromatography column of claim 12, wherein a cross-dimension of each of said first holes is less than said average dimension of said particles.

14. The chromatography column of claim 12, wherein said first holes are arranged in an array.

15. The chromatography column of claim 12, wherein said at least one frit further comprises:
a plurality of first slots formed in said first surface and substantially parallel to one another; and
a plurality of second slots formed in said second surface and substantially parallel to one another, said plurality of second slots being oriented transversely to said plurality of first slots, wherein said plurality of first slots intersect said plurality of second slots thereby forming said plurality of first holes.

16. The chromatography column of claim 12, wherein said first substrate further comprises a support lattice positioned on said first surface, wherein said support lattice defines a plurality of openings, wherein each of said openings is in fluid communication with at least one of said holes.

17. The chromatography column of claim 16, further comprising at least one micro-machined flow distributor positioned between said frit and said respective inlet end or outlet end of said tube, said at least one flow distributor comprising:
a second substrate having a first surface and an oppositely disposed second surface;
a plurality of second holes positioned in and extending through said second substrate, each of said second holes having a first end and an opposed second end positioned on said second surface of said second substrate; and
a plurality of channels defined in said first surface of said second substrate, each of said channels in fluid communication with a first end of at least one of said second holes, wherein each of said first holes of said at least one frit is in fluid communication with at least one of said second holes of said at least one flow distributor.

18. The chromatography column of claim 17, comprising a first said frit and a second said frit, and a first said flow distributor and a second said flow distributor, wherein said first frit is positioned proximate said inlet end of said tube and said second frit is positioned proximate said outlet end of said tube, wherein said extraction medium is contained between said first frit and said second frit, and wherein said first flow distributor is positioned between said first frit and said inlet end and said second flow distributor is positioned between said second frit and said outlet end.

19. The chromatography column of claim 12, wherein said first substrate has a third surface spaced from said second surface, said frit further comprising:
a plurality of channels defined in said third surface, each of said channels in fluid communication with at least one first hole of said plurality of first holes.

20. The chromatography column of claim 19, wherein said first substrate comprises a support lattice extending between said second surface and said third surface, wherein said support lattice defines a plurality of openings, wherein each of said openings provides fluid communication between at least one channel and at least one first hole of said plurality of first holes.
